(19) United States
(12) Patent Application Publication
(10) Pub. No.: US 2009/0266309 A1
(43) Pub. Date: Oct. 29, 2009

(54) LIVESTOCK HANDLING DIVICE

(76) Inventors: Andrew Ronald Hunter, New South Wales (AU); Peter Rutland, New South Wales (AU)

Correspondence Address: TRASKBRITT, P.C., P.O. BOX 2550, SALT LAKE CITY, UT, 84110, US

(21) Appl. No.: 12/225,895

(22) PCT Filed: Mar. 30, 2007
(86) PCT No.: PCT/AU2007/000412

§ 371 Date: Sep. 30, 2008

(30) Foreign Application Priority Data
Mar. 30, 2006 (AU) 2006901647

(51) Int. Cl. A01K 15/04; A01K 1/00; A01K 1/06

(52) U.S. Cl. 119/752; 119/751

(57) ABSTRACT

A device (10) for receiving and confining an animal, such as a bail, is disclosed. The device (10) comprises a pen (12) having at least two elongate walls (21, 22) spaced apart to define a space into which the animal is received. An entry gate assembly (24) is located at a first end of the pen (12) and is movable between an open position, which permits entry of the animal into the pen (12), and a closed position. An exit gate assembly (26) is located at a second end of the pen (12) and movable between an open position, which permits the release of the animal from the pen (12), and a closed position, which prevents release of the animal from the receiving pen (12). At least one of the entry gate assembly (24) and the exit gate assembly (26) includes a pair of door members (30), each having a substantially vertically extending planar surface (32). Each door member (30) is rotatably mounted to the pen (12) at the first and/or second end of the pen such that when the gate assembly (24, 26) is moved to the closed position, the door members (30) rotate such that their planar surfaces (32) abut to extend substantially across the first and or second end of the pen (12), and when the gate assembly (24, 26) is moved to the open position, the door members (30) rotate such that their planar surfaces (32) are located adjacent a respective elongate wall (21, 22) of the pen (12).

### CROSS-REFERENCE TO RELATED APPLICATIONS

The present application is a national phase entry under 35 U.S.C. § 371 of International Patent Application PCT/AU2007/000412, filed Mar. 30, 2007, published in English as International Patent Publication WO 2007/112487, which claims priority from Australian Provisional Patent Application No 2006901647 filed on 30 Mar. 2006, the contents of each of which is incorporated herein by reference.

### FIELD OF THE INVENTION

The present invention relates to a device for handling livestock and, in particular, to a device that facilitates monitoring and sorting of livestock.

### BACKGROUND

In countries such as Australia, the livestock industry contributes greatly to the economical and social wellbeing of the nation. The success of the livestock industry is greatly dependent upon the ability of primary producers, such as farmers, to control and monitor their livestock to ensure an acceptable degree of livestock quality, such that the industry is sustainable.

With increased demands being placed on primary producers, livestock production and maintenance is a business requiring significant investment in both time and resources. In recent times, with the loosening of various trade restrictions between countries, there has been an increase in competition between livestock producers and suppliers, resulting in a need for farmers and other such primary producers to adopt even more efficient work practices to ensure production of a high quality at a competitive price.

The beef industry in Australia is one of Australia's major agricultural industries with about a quarter of the Australian farming establishments deriving their main income from beef cattle farming. The types of farming establishments dedicated to cattle farming varies from intensively managed small holdings in the southeast region of Australia, where water supplies and soil conditions facilitate high stocking rates, to extensive large-scale cattle stations in northern and central parts of Australia, where cattle roam relatively free with minimal regular human contact.

As discussed above, the need to monitor and assess the growth and health of individual animals is important in order to maintain a competitive and sustainable livestock industry. This is typically performed by gathering the animals and individually assessing them and, where necessary, sorting the animals for further processing. The animals are typically sorted in terms of their weight and/or age, such that they can be made available for slaughter and/or selling/export, thereby providing a source of income to the farmer. As the income is typically dependant upon the health and/or condition of the animal, regular monitoring and assessment of the animal is important to ensure maximum return to the farmer.

As such, a number of systems have been introduced to assist the farmer in individually monitoring and assessing their livestock. Such systems typically employ a variety of chutes and gates for individually directing the animals in a controlled manner through a variety of devices whereby an individual animal can be isolated from the rest of the animals for assessment and/or treatment. Assessment may include weighing, branding, applying medical treatment, and/or otherwise examining the animal.

Generally, the chutes are designed to be long and narrow in configuration so as to form an elongate space into which one animal at a time is manually driven. A head gate may be inserted into the chute to prevent the animal from progressing further while a tail gate is driven into the chute behind the animal preventing the animal from backing away from the space, thereby isolating the animal from the other animals for assessment and/or treatment. As will be appreciated, such a manual means of isolating individual animals requires considerable labor that is generally not readily available in remote locations or in instances where the farm is operated by a single farmer with limited assistance. This can also increase farm operating costs due to the need to hire workers to perform such tasks.

For this reason, automated systems have been proposed that are remotely controlled by an operator to initiate capture of an animal within a confined space. These systems can also be used with various drafting devices to provide the operator with the ability to sort the animals into two or more herds following assessment and/or treatment of the individual animals. A common problem with most existing systems is that they employ sliding of swinging gates to close in front of and behind the animal to capture the animal, which can obstruct the animals as they pass through the chutes of the various systems. Such obstructions can significantly reduce the flow of the animals passing through the chutes, thereby resulting in the need for the operator to intervene to urge the livestock to flow in an orderly manner. This is a particular problem when large volumes of livestock are being assessed and the availability of human assistance is scarce.

Further, sliding and/or swinging gates have a tendency to tilt and wedge during use, particularly when used with cattle and the like, which have significant weight and apply significant force against the hinges and rails of the gates during use. This can cause the gates to malfunction, thereby requiring repair and/or replacement. Such repair/replacement of the gates can cause significant delays and unnecessary costs to the farmer. Also, most existing gate arrangements swing or otherwise move beyond the livestock handling area or chutes and into the area occupied by the equipment operators. Such moving components can create and pose significant risks to the wellbeing of the operators.

Therefore, there is a need to provide a livestock handling system that is designed to assist the progress of animals through the system, and that is not prone to malfunction during use, and/or compromise the safety of the operator(s).

A discussion of documents, act, materials, devices, articles or the like, which has been included in the present specification, is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to a first aspect, the present invention is a device for receiving and confining an animal comprising:
a pen having at least two elongate walls spaced apart to define a space into which the animal is received;
an entry gate assembly located at a first end of the pen and movable between an open position, which permits entry of the animal into the pen, and a closed position; and
an exit gate assembly located at a second end of the pen and movable between an open position, which permits the release of the animal from the pen, and a closed position which prevents release of the animal from the receiving pen;
wherein at least one of the entry gate assembly and the exit gate assembly includes a pair of door members each having a substantially vertically extending planar surface, and wherein each door member is rotatably mounted to the pen at the first and/or second end of the pen such that when the gate assembly is moved to the closed position, the door members rotate such that their planar surfaces substantially abut to extend across the first and/or second end of the pen, and when the gate assembly is moved to the open position, the door members rotate such that their planar surfaces are located adjacent a respective elongate wall of the pen.

In one embodiment, when the gate assembly is moved to the open position, the door members rotate such that their planar surfaces are substantially parallel to the respective elongate walls of the pen. In another embodiment, when the gate assembly is moved to the closed position, the door members rotate such that their planar surfaces extend substantially orthogonal to the elongate walls of the pen.

The planar surfaces of each door member may comprise a panel extending between a pair of plates. The plates may be rotatably mounted to the pen such that each door member is able to rotate about a vertical axis.

An elongate roller member may be mounted between the pair of plates so as to extend along an edge of the panel. The edge of the panel may be a distal edge of the planar surface. The elongate roller member may be free to rotate about its vertical axis.

In another embodiment, each door member is rotated between the open and closed positions by a linear actuator connected to at least one of the plates. Reciprocal movement of the linear actuator may cause the door member to rotate about its vertical axis between the open and closed positions. The linear actuator may be a pneumatic ram that is controlled by a control system to provide remote control of either or both of the entry and exit gate assembly. In another form, the linear actuator may be manually operated.

In yet another embodiment, the space into which the animal is received is adjustable to accommodate a wide variety of animal types and sizes. In one form, one or more of the at least two elongate walls of the pen may be moveable to alter the size of the space. In this regard, one or more of the at least two elongate walls of the pen may be inwardly pivotal.

According to a second aspect of the present invention, the present invention provides a gate assembly for a pen for receiving and confining an animal, comprising:
a pair of door members rotatably mounted to the pen so as to independently rotate about a vertical axis, each door member having a substantially vertically extending planar surface; and
a linear actuator mounted to the pen so as to be in connection with the pair of door members;
wherein actuation of the linear actuator in a first direction causes the pair of door members to rotate such that their planar surfaces extend substantially orthogonal to a direction of travel of the animal so as to close an opening of the pen, and actuation of the linear actuator in a second direction causes the pair of door members to rotate such that their planar surfaces are located substantially parallel to the direction of travel of the animal so as to open an opening of the pen.

According to an embodiment of this aspect of the invention, the planar surfaces of each door member comprise a panel extending between a pair of plates. The plates may be rotatably mounted to the pen such that each door member is able to rotate about a vertical axis.

An elongate roller member may be mounted between the pair of plates so as to extend along an edge of the panel. The edge of the panel may be a distal edge of the planar surface.

According to a third aspect, the present invention is a livestock receiving device for receiving and confining an animal compromising:
at least two side walls spaced apart to define an elongate receiving space into which the animal is received;
an entry gate assembly located at a first end of the receiving space and movable between an open position, which permits entry of the animal into the receiving space, and a closed position, which prevents entry of the animal into the receiving space; and
an exit gate assembly located at a second end of the receiving space and movable between an open position, which permits the release of the animal from the receiving space, and a closed position, which prevents release of the animal from the receiving space;
wherein at least one of the entry gate assembly and the exit gate assembly includes at least one vertically extending gate member that is rotated between the open position and the closed position such that movement of at least one gate member does not extend beyond a perimeter of the device.

In one embodiment of this aspect of the invention, at least one of the entry gate assembly and the exit gate assembly comprises a pair of vertically extending gate members arranged proximal the side walls of the receiving space. Each of the gate members may be configured such that when they are in the open position, they are substantially parallel to the side walls along each side of the receiving space, and when they are in the closed position, they extend substantially orthogonal to the side walls.

Each gate member may comprise a panel extending between a pair of plates. The plates may be mounted to the device such that the gate member is able to rotate about a vertical axis, thereby moving the panel between an open position where the panel is substantially parallel to the side walls and a closed position where the panel extends substantially orthogonal to the side walls. A roller member may extend along an edge of the panel. The edge of the panel may be a leading edge of the panel; namely the outermost edge of the panel when the panel is rotated to the closed position. The roller member may be mounted between the plates such that it is free to rotate about a vertical axis. In this arrangement, the roller member may contact the animal as the gate member opens and/or closes, such that the gate member is able to ride over the animal.

The gate member may be rotated between the open and closed positions by a linear actuator connected to at least one of the plates. Reciprocal movement of the linear actuator may cause the gate member to rotate about its vertical axis between the open and closed position. In one form, the linear actuator may be a pneumatic ram, which is controlled by a control system to provide remote control of either or both of the entry and exit gate assemblies. In another form, the linear actuator may be manually operated.

In another embodiment, the receiving space may be provided with a weighing scale to obtain the weight of the animal received within the receiving space. In this arrangement, the device may comprise an electronic reading device to read an identification tag of an animal, such as an ear tag or an electronic chip implanted under the animal's skin, to identify the animal such that the obtained weight can be stored against the animal. A control system may store the obtained weight data with the animal to facilitate sorting of the animals into desired groups upon leaving the receiving space. In this regard, a sorting or drafting device may be arranged proximal the exit gate assembly and controlled by the control system to sort the animal upon exiting the receiving space.

In another embodiment, the receiving space may be adjustable to accommodate a wide variety of animal types and sizes. In this regard, one or more of the at least two side walls may be moveable to alter the size of the receiving space. A locking means may be provided to lock the side walls in one of a variety of positions, according to the size and/or type of animal being handled.

According to a fourth aspect, the present invention is a livestock receiving device for receiving and confining an animal comprising:
at least two side walls spaced apart to define an elongate receiving space into which the animal is received;
an entry gate assembly located at a first end of the receiving space and movable between an open position, which permits entry of the animals into the receiving space, and a closed position, which prevents entry of the animal into the receiving space; and
an exit gate assembly located at a second end of the receiving space and movable between an open position, which permits the release of the animal from the receiving space, and a closed position, which prevents release of the animal from the receiving space;
wherein at least one of the side walls is movable with respect to another of the side walls so that the elongate receiving space can be altered to receive animals of varying sizes.

According to a fifth aspect, the present invention is a gate assembly for a livestock handling device comprising:
a vertically extending panel mounted between a pair of mounting plates;
an elongate roller arranged to extend along an edge of the panel between the plates and being free to rotate about its axis;
wherein the mounting plates are configured to be mounted to the device such that the panel and roller can rotate between an open and closed position.

Throughout this specification the word “comprise,” or variations such as “comprises” or “comprising,” will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

By way of example only, preferred embodiments of the intention are now described with reference to the accompanying drawings, in which:

FIG. 1 is a perspective view of one embodiment of the livestock handling system of the present intention;

FIG. 2 is a top view of the embodiment of FIG. 1;

FIGS. 3 and 4 are perspective views of the pen of the system of FIGS. 1 and 2 showing the entry gates in the closed and open positions, respectively;

FIGS. 5A and 5B are front and side views, respectively, of one embodiment of the door members of the entry and exit gates of the system of FIG. 1;

FIGS. 5C and 5D are top views of the door members of FIGS. 5A and 5B, respectively;

FIGS. 6A and 6B are front and rear views of the door members of FIGS. 5A to 5D in the closed position; and

FIG. 7 is a top view of the pen of FIG. 1.

### DETAILED DESCRIPTION OF THE PREFERRED EMBODIMENTS

A livestock handling device 10 in accordance with one embodiment of the present invention is shown generally in the accompanying figures. While the device 10 will be described in relation to its use in handling cattle, it will be appreciated that the device 10 could be equally employed for handling a variety of livestock, such as sheep, pigs and the like.

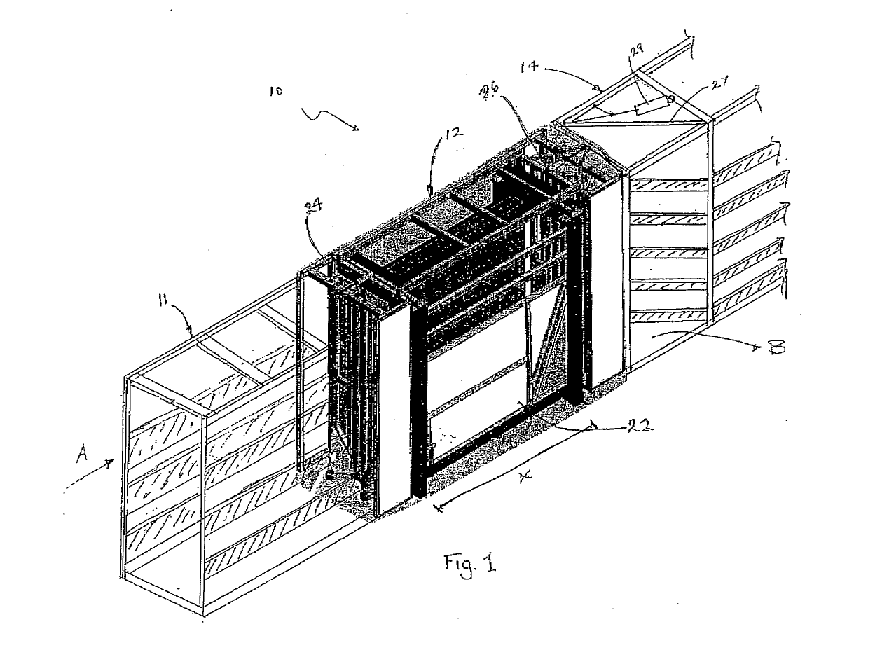

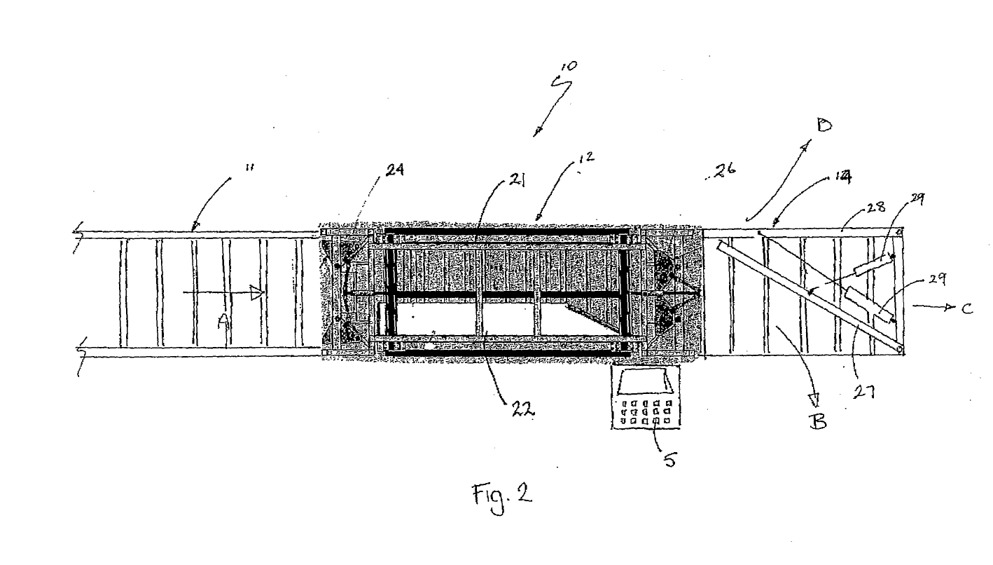

As shown in FIGS. 1 and 2, the device 10 generally comprises a pen 12 for isolating and holding an individual animal and a sorting device 14 for sorting the animals exiting the pen 12. The cattle may be sorted into at least two herds in accordance with a variety of sorting methods, which will be discussed in more detail later in the description.

A chute 11 is provided to feed the cattle into the pen 12 in the direction of arrow A. The chute 11 is constructed such that the cattle can move in a single line towards the pen 12, with minimal obstruction to hamper their progress. In this regard, the chute 11 could be constructed in a variety of forms, as would be appreciated by those skilled in the art. The cattle may be manually urged or prodded to travel along the chute 11 by a farmer or other individual, or the cattle may naturally progress along the chute 11 due to the orientation of the chute 11 with respect to its surroundings.

The pen 12 is in the form of an enclosure having a pair of upright side walls 21, 22 arranged substantially parallel to the path of the cattle moving in the direction of arrow A. The walls 21, 22 are spaced apart a sufficient distance to accommodate the cattle passing therethrough such that an individual animal can be comfortably received therebetween. The walls 21, 22 are constructed in a manner that retains the animal within the pen 12 and that also enables a farmer to access the animal in a manner as will be discussed in more detail below.

Entry gates 24 are provided at one end of the pen 12, proximal the chute 11. The entry gates 24 are actuated to move between an open position that permits entry of an animal into the pen 12, and a closed position and prevents the animal within the pen 12 from backing out of the pen 12, as well as other animals entering the pen 12. Exit gates 26 are also provided at an end proximal the sorting device 14, and are controlled to move between a closed position that encloses the animal within the pen 12, and an open position that releases the animal from the pen 12 into the sorting device 14. Upon entry of the animal into the sorting device 14, the animal is sorted or drafted into an appropriated holding pen or race in accordance with a desired drafting/sorting regime employed by the farmer, which is not the subject of the present invention.

As shown more clearly in FIG. 2, the walls 21, 22, entry gates 24 and exit gates 26 define a space into which an animal is received so that it can be isolated from the rest of the herd for monitoring and/or assessment by a farmer. The length of the pen 12, namely the length of the space between the entry gates 24 and the exit gates 26 (shown as X in FIG. 1) is sufficient to accommodate the type of animal to be assessed/monitored. In this regard, the length X of the pen 12 may vary and is typically selected by the farmer in accordance with the type of livestock to be passed through the pen 12. In the embodiment as shown, the length X is sufficient to accommodate cattle of variable lengths.

As will be discussed below, as the cattle move through the device 10, the operator controls the operation of the entry gates 24 to close behind the animal thereby capturing the animal in the pen 12 between the entry gates 24 and closed exit gates 26. The entry gates 24 may be remotely actuated by the operator through a remote control pad or the like (not shown). In this regard, the opening and closing of the entry gates 24 can by synchronized to control the progress of the cattle through the device 10.

By isolating the animal in the pen 12 as it progresses through the chute 11 to the sorting device 14, the animal can be monitored/assessed by the farmer/operator in a variety of ways. In the embodiment as shown, the pen 12 is configured to function as a weighbox for weighing the individual animals as they pass therethrough. In this arrangement, the weight of the animal can be ascertained and recorded to provide the operator with a record of the history of the animal, which can be used to ascertain the readiness of the animal for sale, and/or the health and condition of the animal. Upon assessing the weight of the animal, the sorting device 14 can be controlled to sort the cattle according to their weight.

It will be appreciated that while the pen 12 is described in relation to a weighbox for measuring the weight of animals passing therethrough, the pen 12 could also be arranged to perform a variety of functions, for example, as a “cattle crush,” to capture the animal to assist a farmer in administering medication to the animal or branding the animal.

The sorting device 14 is arranged adjacent the exit gates 26 of the pen 12 such that when the exit gates 26 open and the animal exits the pen 12, the animal enters the sorting device 14. The sorting device 14 comprises an elongated chute, similar to chute 11, having a pair of pivoting side walls 27, 28. The side walls 27, 28 are positioned to direct the exiting cattle in a desired direction under the action of one or more pneumatic actuators 29. In the embodiment as shown in FIGS. 1 and 2, the side wall 27 is pivoted towards side wall 28, thereby directing the exiting cattle in the direction of arrow B. It will be appreciated that by positioning the walls 27, 28 such that they are substantially parallel with the pen 12, the exiting animals will be directed along path C, and by positioning side wall 27 such that it is substantially parallel with pen 12 and moving side wall 28 towards side wall 27, the animals will be directed along path D. As discussed above, the path, which the exiting cattle take, is controlled in accordance with the measured weight of the animal. However, other factors can be used to determine the desired path of the exiting animal.

A control system 5 is provided to control and coordinate the overall operation of the device 10. The control system 5 generally comprises a central computer, such as a portable lap top computer, which controls the actuation of the entry and exit gates 24, 26 and the weighing arrangement of the pen 12, as well as the pneumatic actuators 29 of the sorting device 14. In this regard, the control system 5 can be employed so that the cattle passing through the device 10 can be sorted according to their measured weight. The control system 5 may comprise a memory storage that stores and records the weight data for each individual animal to provide to the operation information pertaining to the history of the animal, together with any other pertinent information. In this regard, an electronic reader may also be mounted to the pen 12 or chute 11 to identify the animal entering the pen 12 such that the weight of the animal can be stored against that particular animal. In this regard, the animal may be provided with an identification device, such as an ear tag or implanted microchip, which is detected by the electronic reader as the animal passes the reader to identify the individual animal. Such systems are well known in the art and will not be described in further detail. It will be appreciated that the control system 5 could also be in the form of an integrated computer system provided within the pen 12 or sorting device 14.

The control system 5 can be easily operated by a sole operator, thereby substantially reducing the requirement for additional labor to assist weighing and recording the information for each animal.

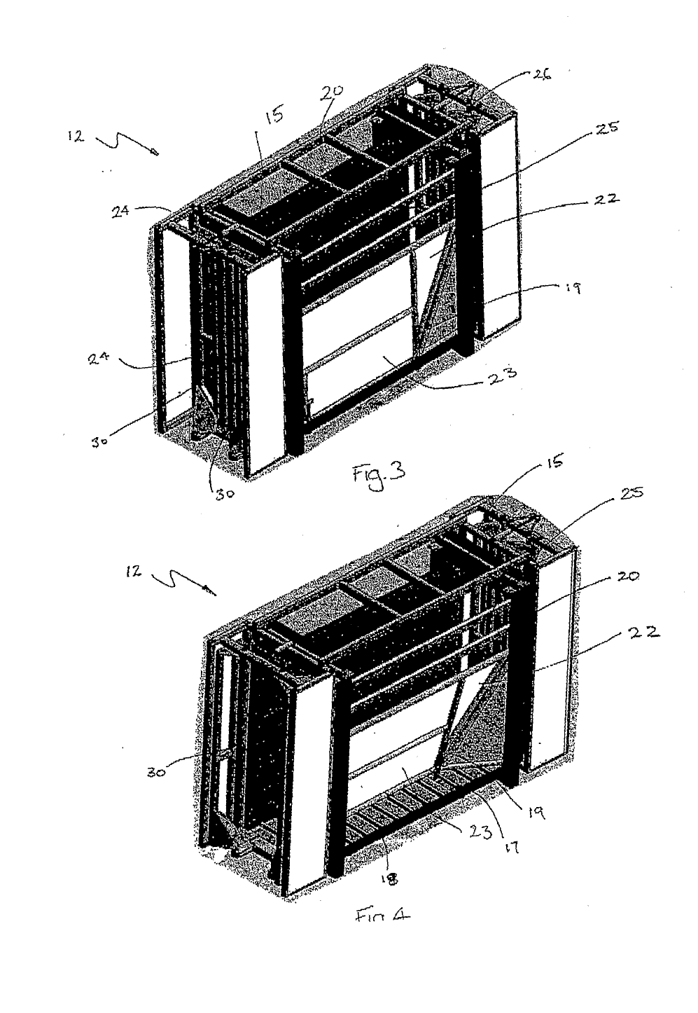

Referring to FIGS. 3 and 4, the pen 12 of device 10 is shown in isolation. In FIG. 3, both the entry gates 24 and exit gates 26 are shown in the closed position as is the case when an animal is positioned within the pen for weighing. The pen 12 comprises a substantially rectangular frame 20 forming a substantially rectangular holding space for holding the animal, defined by the wall 21, 22 and gates 24 and 26. The holding space is designed to accommodate the animal as securely as possible and to prevent the animal from turning around or significantly moving within the holding space. Such an arrangement reduces the likelihood of the animal causing harm or injury to itself by becoming cast or stuck within the pen 12, and also reduces the likelihood of the animal causing damage to the pen 12 as a result of moving within the holding space.

As is shown in FIG. 3, the upper portion 25 of the walls 21, 22 are substantially open and comprise an enclosed lower portion 23 made from a sheet of galvanized steel or the like. The open upper portion 25 is in the form of one or more steel bars. Such an arrangement provided in the upper portion 25 reduces the likelihood of any portion of the animal, such as the animal's legs, protruding or otherwise extending through the wall 21, 22, as the enclosed lower portion 23 leaves no exposed gaps through which limbs can extend. This is particularly important if the animal becomes agitated and attempts to kick-out when in the pen 12. The open upper portion 25 provides the operator with the ability to access the animal to administer medication or the like to the animal as required.

As will be appreciated, cattle sizes can vary depending on a variety of factors, in particular the age of the individual animals. Hence, the holding space of the pen 12, is generally designed so as it can readily accommodate the largest cattle sizes. In many instances, particularly where calves are being weighed and handled, the holding space of the pen 12 may be too large for the calves. Such an overly large holding space, can allow the animal to move around within the holding space of the pen, increasing the likelihood of the animal causing damage to the pen 12 or causing injury and harm to itself.

As shown in FIG. 4, in order to deal with variable cattle sizes, the enclosed lower portion 23 of the side wall 22 is pivotally adjustable inwards. This inward pivotal movement of the side wall 22 reduces the width of the holding space of the pen 12 such that the animal is securely retained between the walls 21, 22 of the pen 12, thereby being prevented from turning around within the pen 12.

To facilitate pivotal movement of the side wall 22, the upper end of the enclosed lower portion 23 is pivotally connected to the frame 20 of the pen 12. This allows the lower end to pivot inwards towards the wall 21. An anchor pin 19 is provided adjacent to the lower end of the enclosed lower portion 23, which is spring loaded to be received in one of a plurality of holes 17 provided in the floor 18 of the pen 12. While only one side wall of the pen 12 is shown as being inwardly pivotal and adjustable, it will be appreciated that either or both side walls may be adjustable to facilitate a wide variety of animal sizes and shapes.

While not shown in FIGS. 3 and 4, the pen 12 comprises a plurality of load cells mounted in the roof 15 of the pen 12, to weigh the animal as it stands upon the floor 18 of the pen 12.

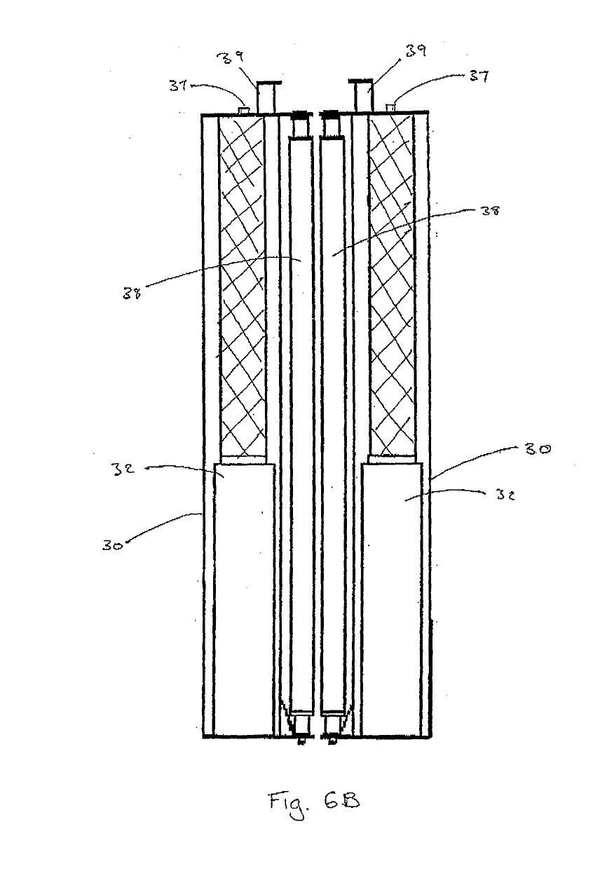

The animal is permitted into the pen 12 by moving the entry gates 24 from the closed position as shown in FIG. 3 to the open position as is shown in FIG. 4. In the closed position, shown more clearly in FIG. 6A, the entry gates 24 substantially block the path of the animal, presenting a substantially solid wall to the animal. When the entry gates 24 are in the open position, they provide a straight open path for the animal to pass, substantially free of obstacles, which may cause the animal to baulk or become unsure of what lies ahead of them. Such an arrangement is important, particularly with respect to providing steady flow of cattle through the device 10, as any obstruction may require operator intervention to force the animal against their will through the device 10.

A similar arrangement is provided with the exit gates 26. In this arrangement, when the animal progresses into the pen 12 and is presented on the floor 18 of the pen 12 for weighing by the load cells, the exit gates 26 are in the closed position as shown in FIG. 6B. In this position, the exit gates 26 extend across the animal's path, thereby presenting a solid obstacle to the animal. Following weighing of the animal, the exit gates 26 are moved to their open position, thereby providing a straight open path for the animal to pass, substantially free of obstacles, which may cause the animal to baulk or become unsure of what lies ahead of them.

The configuration of the gates 24, 26 and the manner in which they move between open and closed positions provides additional assistance in progressing the animal into and out of the pen 12. In the embodiment as shown in FIGS. 3 and 4, the configuration of the entry gates 24 and the exit gates 26 is substantially the same. However, it will be appreciated that the entry gates 24 and the exit gates 26 could vary in construction and still fall within the spirit of the present invention.

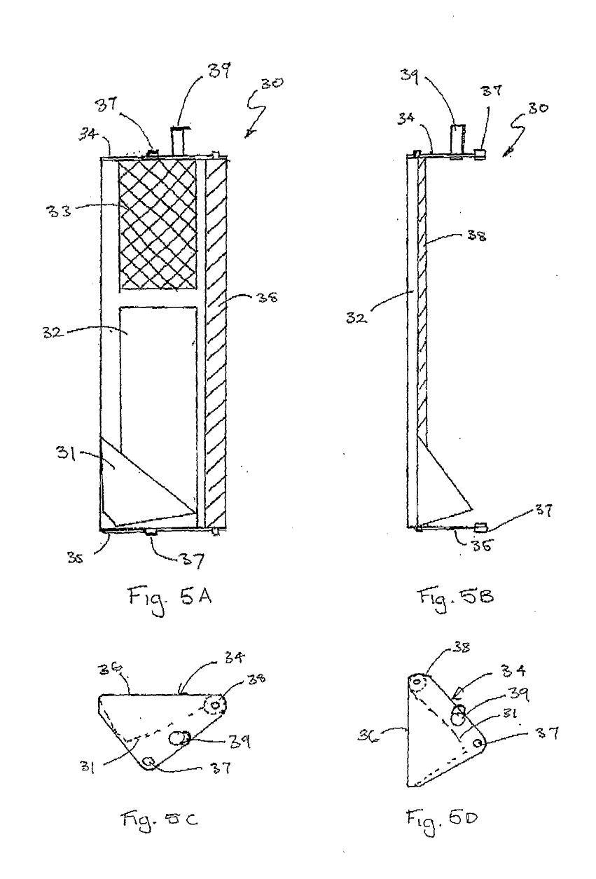

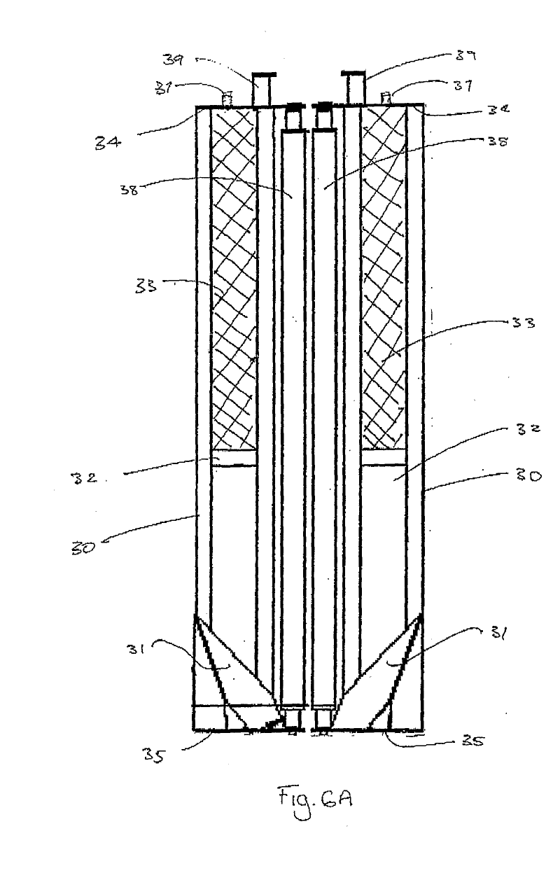

Referring to FIGS. 5A and 5B, one embodiment of the entry gates 24 and exit gates 26 is shown. The gates 24, 26 comprise a pair of opposing door members 30, which are activated to open and close the ends of the pen 12 so as to permit entry of the animal into the holding space of the pen 12, and exit of the animal from the pen 12.

As shown more clearly in FIGS. 3 and 4, each door member 30 has a height that extends substantially the height of the pen 12. In this regard, for handling cattle, the height of the door may be between 1.9-2.2 meters to facilitate a variety of cattle types and sizes. The door member 30 comprises a planar surface or panel 32, which is substantially flat and extends the length of the door member 30. The panel 32 may be formed from a sheet of galvanized steel such that the lower portion of the panel 32 is fully enclosed. An opening 33 (as shown by cross hatches in FIG. 5A) may be provided in the upper portion of the panel 32, which opens into the holding space of the pen 12. A guide member 31 is attached to the lower portion of the panel 32 and is angled to extend downward and away from the panel 32. The guide member 31 is made from a sheet of galvanized steel, the purpose of which will be discussed in detail below.

The panel 32 extends between an upper pivot plate 34 and a lower pivot plate 35. As shown in FIGS. 5C and 5D, the pivot plates 34, 35 are substantially triangular in shape and are made from a sheet of galvanized steel, thereby enabling the panel 32 to be welded or otherwise attached between the plates 34, 35. In this regard, the panel 32 is attached to the plates 34, 35 along a base edge 36, which forms the base of the triangular plates 34, 35 (see FIGS. 5C and 5D). In this arrangement, the width of the panel 32 is such that it extends from one end of the base edge 36 of the plates 34, 35, but terminates before reaching the other end. This then results in a gap being formed between the end of the panel 32 and the end of the base edge 36 of the plates 34, 35.

A roller 38 is mounted in this gap to extend longitudinally between the pivot plates 34, 35. The roller 38 is made from steel and is mounted such that it is free to rotate between the plates 34, 35 along its longitudinal axis. In this arrangement, the roller 38 is an extension of the panel 32 such that both the panel 32 and the roller 38 form a wall of the door member 30. In this regard, when opposing door members 30 are in a closed position such that they are in abutting arrangement across the opening/exit of the pen 12 (as shown in FIGS. 6A and 6B), the rollers 38 of each of the door members 30 are located adjacent to each other.

A pivot pin 37 extends from the outer surface of each of the pivot plates 34, 35 to facilitate mounting of the door member 30 to the frame 20 of the pen 12 as shown in FIGS. 3, 4 and 7. In this arrangement, the door members 30 are mounted at either sides of the opening to the pen 12, and rotate with respect to the pen 12 to open and close the ends of the pen 12. As shown in FIGS. 5C and 5D, the pivot pin 37 is positioned opposite the base edge 36 of the plates 34, 35, namely in the angle joining the other two sides on the plates 34, 35. This arrangement allows the door member 30 to rotate about the pivot pin 37 under action of a pneumatic actuator, such that the door member can be moved between the opening and closing positions as will be discussed in more detail below. An actuator post 39 is also provided along an edge of the upper pivot plate 34 that extends between the roller 38 and the pivot pin 37, to facilitate connection to a pneumatic actuator such that rotational movement can be imparted to the door member 30.

FIG. 6A shows the door members 30 of the entry gates 24 in a closed position, as seen from the perspective of an animal awaiting entry into the pen 12. As is shown, the door members 30 provide a barrier, which prevents an animal progressing further along the chute 11 into the pen 12. The guide members 31 arranged at the lower portion of the panels 32 prevent the feet of the animal gripping the edge of the pen 12, as they are angled to deflect the animal's feet away from the pen 12. This arrangement prevents the animal awaiting entry in the pen 12 from stepping on the floor of the pen 12 which could have an adverse affect on the weight measurement being taken by the load cells of the pen 12. Further, it ensures that the next animal entering the pen 12 is away from the entry gates 24 as they open, to assist the operator in controlling movement of the animals through the device.

As is shown, when the door members 30 are in the closed position, the rollers 38 are arranged adjacent to each other with a small gap provided therebetween. This gap may be around 40-50 mm in width, thereby preventing the tail of the animal being caught between the closing door members 30. Pinching of the animal's tail between the door members 30 as they close may cause irritation to the animal.

FIG. 6B shows the door members 30 of the entry and exit gates 24, 26 in the closed position as seen from within the pen 12. In this arrangement, the panels 32 present a substantially flat surface to the animal, thereby enclosing the animal within the pen in a relatively safe and secure manner.

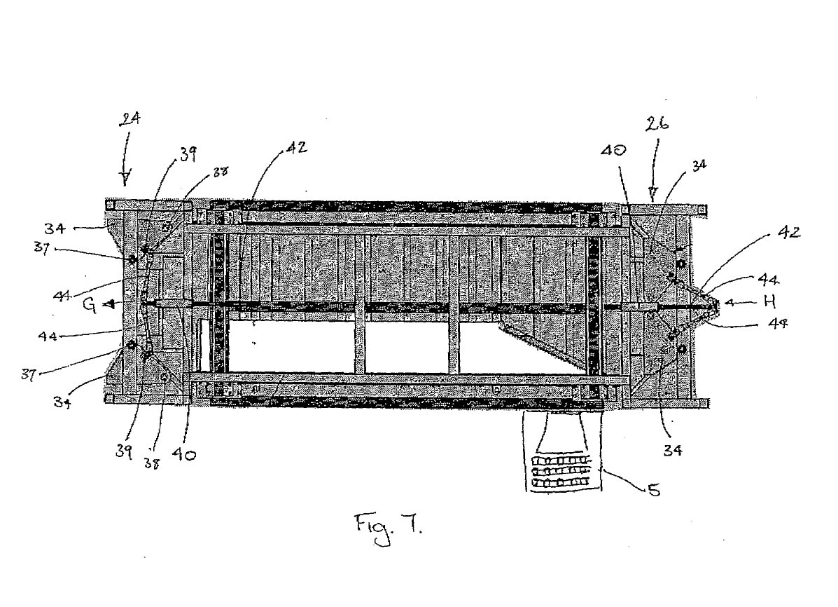

As alluded to above and shown in FIG. 7, the opening and closing operation of the entry and exit gates 24, 26 is controlled by the control system 5, which in turn is controlled by an operator. The control system 5 communicates with a pneumatic actuator 40 to move a reciprocating piston 42 in a desired direction. As shown, the pneumatic actuator 40 is centrally mounted in the roof 15 of the pen 12, such that the piston 42 is positioned substantially between the door members 30 at each end of the pen 12. The piston 42 is attached at an end thereof to the actuator posts 39 extending from the upper pivot plates 34 of the door members 30 by linking arms 44.

In order to open the pen 12, the operator provides a signal whereby the control system causes the pneumatic actuator to move the piston 42 such that it is retracted within the actuator 40, as shown with respect to entry gates 24 of FIG. 7. In this position, the door members 30 of the entry gates 24 rotate to an open position, thereby permitting entry of the animal into the pen 12. In the open position, the panel 32 of the door members 30 is arranged parallel to the direction of the movement of the animal, thereby providing a substantially open and unrestricted path for the animal to travel into the pen 12. The panels 32 of the door members 30 are rotated out of the way of the progressing animal such that they are located substantially adjacent the side walls 21, 22 of the pen 12, so as not to substantially restrict the size of the opening of the pen 12.

Upon receiving the animal in the pen 12, the control system sends a signal to the pneumatic actuator 40 to move the piston 42 into an extended position whereby the piston is moved in the direction of arrow G, out of the actuator 40. Movement of the piston 42 in this manner causes the linking arms 44 to pull against the actuator posts 39 so as to impart rotational motion to the pivot plates 34, thereby rotating the door members 30 into the closed position as shown in FIGS. 6A and 6B. As the rollers 38 are arranged along the leading edge of the door members 30, when the door members 30 are brought into the closed position, the rollers 38 ride across the rump of the animal as they close. Such an arrangement provides a positive force against the rear of the animal urging the animal into or out of the pen 12. As the door members 30 roll across the rear of the animal, there is no significant pinching or squeezing of the animal that may cause discomfort resulting in the animal becoming agitated. Further, this action ensures that the door members 30 close around the animal, thereby substantially reducing the likelihood of more than one animal entering the pen 12 at any one time.

Following admittance of the animal into the pen 12 and closing the entry gates 24, the animal is then weighed by the load cells, whereby the control system 5 sets the sorting device 14 to direct the animal to a desired holding region. The exit gates 26 are then opened by the control system 5 causing the pneumatic actuator 40 to retract the piston 42 in the direction of arrow H. This in turn causes the door members 30 to rotate into their open position, whereby the panel 32 is parallel to the direction of movement of the animal, which provides a clear passage for the animal to exit the pen 12 and enter the sorting device 14 to be delivered to the desired holding region.

Once the animal is clear of the pen 12, the operator can then indicate to the control system 5 to open the entry gates 24 to allow the waiting animal to enter the pen 12 for weighing.

While operation of the entry and exit gates 24, 26 has been described above as being pneumatically actuated, it will be appreciated that the gates 24, 26 could also be manually actuated by an operator and still fall within the spirit of the present invention.

Further, it will be appreciated that while the above invention has been described as being controlled by a control system, such as an automated computerized control system, the present invention could be manually controlled as desired.

It will be appreciated that the present invention provides a system for handling livestock that enhances the natural progression of the animal through the entire system. The rotary action of the entry and exit gates of the system provides a simple means for directing and guiding the animal into an enclosed space, without the need for excessive human intervention. Such rotational action of the entry and exit gates prevents tilting/jamming of the gates, which is common with existing sliding/swinging gate systems and also ensures that the doors operate within a confined space that does not extend beyond the pen and into the area occupied by the operators. Such a rotational action of the gates also provides for quick actuation of the gates to ensure that individual animals are captured and released from the pen as desired, thereby greatly improving the handling ability of the device. Further, the ability to alter the holding space of the system allows a system that can safely cater for a variety of sizes of stock, reducing the possibility of injury to livestock and equipment.

It will be appreciated by persons skilled in the art that numerous variations and/or modifications may be made in the invention as shown in the specific embodiments without departing from the spirit or scope of the invention as broadly described. The present embodiments are, therefore, to be considered in all respects as illustrative and not restrictive.

1. A device for receiving and confining an animal comprising:
a pen having two elongate walls spaced apart to define a space into which the animal is received;
a gate assembly located at an end of the pen and movable between a closed position which the animal initially faces and an open position which permits said animal to pass thereby; and
wherein said gate assembly includes a pair of upright generally planar door members, and wherein each door member is rotatably mounted to said pen about an upright rotation axis spaced from the general plane of the door member such that when the gate assembly is in its closed position each door members has its general plane extending transversely across the end of the pen, and when the gate assembly is moved from its closed position to the open position each door members simultaneously retracts and rotates as it moves about its rotation axis such that its general plane translates to a location adjacent a respective elongate wall of the pen.

2. A device according to claim 1, wherein when the gate assembly is moved from the closed position to the open position the door members rotate and translate such that their general planes are substantially continuous with the respective elongate walls of the pen.

3. A device according to claim 1, wherein when the gate assembly is moved to the closed position the door members rotate such that their general planes extend substantially orthogonal to the elongate walls of the pen.

4. A device according to claim 1, wherein each door member comprises an upright panel extending between and mounted by upper and lower pivot members pivotally mounted to the pen for rotation about the upright rotation axis spaced from the general plane of the panel.

5. (canceled)

6. A device according to claim 4, wherein an elongate roller member is mounted between the upper and lower pivot members of each door member and extending along an edge of the panel so that an animal passing the door member and contacting the edge makes a rolling contact therewith.

7. (canceled)

8. A device according to claim 6, wherein the elongate roller member is free to rotate about its vertical axis.

9. A device according to claim 8, wherein each door member is rotated and translated between the open and closed positions by a linear actuator connected to one of the pivot members at a position displaced from the rotation axis.

10. A device according to claim 9, wherein selective reciprocating movement of the linear actuator causes the door member to rotate and translate about its vertical rotation axis between said open and closed positions.

11. A device according to claim 10, wherein the linear actuator is a pneumatic ram which is controlled by a control system to provide remote control of the gate assembly.

12. (canceled)

13. A device according to claim 1, wherein the space into which the animal is received is adjustable to accommodate a wide variety of animal types and sizes.

14. A device according to claim 13, wherein one or more of the at least two elongate walls of the pen are moveable to alter the size of the space.

15. A device according to claim 14, wherein one or both of the two elongate walls of the pen are inwardly pivotal about a horizontal axis.

16. A gate assembly for a pen for receiving and confining an animal, comprising:
a pair of upright generally planar door members rotatably mounted to said pen so that each door member is rotatable about its respective upright rotation axis spaced from the general plane of the door member; and
a linear actuator mounted to said pen so as to be in operative connection with said pair of door members; wherein
actuation of said linear actuator in a first direction causes said pair of door members to rotate about their respective spaced rotation axes such that they extend transversely relative to a direction of travel of the animal so as to close an opening of said pen, and actuation of said linear actuator in a second reverse direction causes said pair of door members to simultaneously retract upon rotation about their respective spaced rotation axes such that their general planes translate to locations substantially parallel to the direction of travel of the animal and at opposite sides of the path of travel of the animal so as to open an opening of said pen.

17. A gate assembly according to claim 16, wherein each door member comprises an upright panel extending between and mounted by upper and lower pivot members pivotally mounted to the pen for rotation about the upright rotation axis spaced from the general plane of the panel.

18.-20. (canceled)

21. A gate assembly according to claim 17 wherein each of the upper and lower pivot members comprises a generally horizontal triangular shaped pivot member having one edge of the triangular shape attached at the respective upper or lower edge of the associated upright panel and further includes a pivot pin at the apex of the triangular shape opposite to the edge attached to the panel, each triangular shaped pivot member being mounted to the pen so as to be rotatable about the upright rotation axis passing through the pivot pin, and wherein the linear actuator is connected to one of the triangular shaped pivot members associated with each door member at an actuation point spaced from the pivot pin so that the actuator applies a turning moment of force to the triangular shaped pivot member.

22. A device according to claim 16, wherein an elongate roller member is mounted between the upper and lower pivot members of each door member and extending along an edge of the panel so that an animal passing the door member and contacting the edge makes a rolling contact therewith.

23. A device according to claim 22, wherein the elongate roller member is free to rotate about its vertical axis.

24. A method of processing a live animal travelling along a confined path by receiving and confining the animal, the method comprising:
providing a pen having two elongate walls spaced apart to define a space into which the animal is received a gate assembly located at an end of the pen and movable between a closed position which the animal initially faces and an open position which permits said animal to pass thereby and said gate assembly including a pair of upright generally planar door members, each door member having an inner edge where the two door members most closely approach each other when the gate assembly is in its closed position, and each door member having an elongated roller member extending along substantially the entire height of the respective inner edge of the door member and being mounted for rotation about an upright rotation axis, and each door member being rotatably mounted to said pen about an upright rotation axis spaced from the general plane of the door member such that when the gate assembly is in its closed position each door member has its general plane extending transversely across the end of the pen, and when the gate assembly is moved from its closed position to the open position each door member simultaneously retracts and rotates as it moves about its rotation axis such that its general plane translates to a location adjacent a respective elongate wall of the pen;
processing the animal by causing the animal to move along the confined path until it reaches the gate assembly which is initially in its closed position so that the animal faces the planar door members;
operating the gate assembly so that the planar door members simultaneously commence to move and each door member retracts and rotates as it moves about its rotation axis and its general plane translates towards a location adjacent a respective one of the elongate walls of the pen;
allowing the animal to advance if it wants to do so, along the travel path as the gate assembly is in the process of moving from its closed position to its open position so that the animal, when passing between the door members before they reach the open position, upon contacting the inner edge of either of the door members will contact and move past the respective roller member so that there will be a rolling contact between the door member inner edges and the animal; and
operating the gate assembly when the animal has substantially passed the door members so as to move the door members from their open position to the closed position and thereby provide a barrier gate facing an animal following behind the animal now in a position past the closed gate assembly.
